(19) United States
(12) Patent Application Publication
(10) Pub. No.: US 2014/0279617 A1
(43) Pub. Date: Sep. 18, 2014

(54) METHOD AND SYSTEM FOR AN ONLINE ADVOCACY PLATFORM

(71) Applicant: WHOLECROWD LLC, Washington, DC (US)

(72) Inventor: James ANDERSON, Washington, DC (US)

(73) Assignee: Wholecrowd LLC, Washington, DC (US)

(21) Appl. No.: 13/829,379

(22) Filed: Mar. 14, 2013

(51) Int. Cl. G06Q 50/00; H04L 12/58

(52) U.S. Cl. CPC G06Q 50/01; H04L 51/32
USPC 705/319

(57) ABSTRACT

A system and method for establishing an online advocacy crowd. A crowd page may be generated and named according to an agenda of a user. Keywords or phrases may be entered into an online interface. A search of the keywords or phrases may be performed by listening across a number of digital and social media sources. Digital and social media posts containing the keywords or phrases may be identified and returned to the user. A contact for each identified post may be determined and saved as a potential crowd member. The user may then selectively invite potential crowd members to join a crowd via the crowd page.

### BACKGROUND

Online platforms such as digital and social media allow for interactions among people to create, share, and exchange content in virtual communities and networks. For businesses, organizations, and advocacy groups, information from various platforms can provide valuable feedback regarding how a particular brand, campaign, or message is generally being perceived. Additionally, these online platforms can help promote or strengthen a brand or message by reaching out and directly engaging customers, followers, fans, or other interested parties.

However, the sheer amount of information available on these online platforms can be overwhelming. There are hundreds of millions of online users across a wide range of platforms. Filtering through the volume of information can therefore be very difficult. Thus, being able to efficiently seek and find the users online who are talking about a particular issue, brand, or message, and target and engage them directly can be very valuable.

### SUMMARY

According to one exemplary embodiment, a system and method for establishing an online advocacy crowd may be disclosed. A crowd page may be generated and named according to an agenda or purpose of a user. At least one keyword or phrase may be entered into an online interface. A search of the keywords and phrases may be performed by listening across a plurality of digital and social media sources. Digital and social media posts containing the keywords or phrases may be identified and returned to the user. A contact for each identified post may be determined and saved as a potential crowd member. The user may then selectively invite potential crowd members to join a crowd via the crowd page.

According to another exemplary embodiment, a system and method for establishing an online advocacy crowd may be disclosed. A crowd page may be generated and named according to an agenda or purpose of a user. A search of the keywords and phrases may be performed by listening across a plurality of digital and social media sources. Digital and social media posts containing the keywords or phrases may be identified and returned to the user. A contact for each identified post may be determined and saved as a potential crowd member.

### BRIEF DESCRIPTION OF THE DRAWINGS

Advantages of embodiments will be apparent from the following detailed description of the exemplary embodiments. The following detailed description should be considered in conjunction with the accompanying figures in which:

FIG. 1 is a diagram of an exemplary computer system.

FIG. 2 is an exemplary embodiment of a method for establishing an online advocacy crowd.

FIG. 3 is another exemplary embodiment of a method for establishing an online advocacy crowd.

FIG. 4 is another exemplary embodiment of a method for establishing an online advocacy crowd.

FIG. 5 is an exemplary embodiment of a crowd page of an online advocacy platform.

FIG. 6 is an exemplary embodiment of an analytics page of an online advocacy platform.

FIG. 7 is an exemplary embodiment of a communications page of an online advocacy platform

FIG. 8 is an exemplary embodiment of a page of an online advocacy platform.

FIG. 9 is an exemplary embodiment of a page of an online advocacy platform.

FIG. 10 is an exemplary embodiment of a page of and online advocacy platform.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

Generally referring to FIGS. 1-4, a method and system for an online advocacy platform may be shown.

FIG. 1 illustrates an exemplary computer system 111 upon which an embodiment of the online advocacy platform may be implemented. The computer system 111 includes a bus 112 or other communication mechanism for communicating information, and a processor 113 coupled with the bus 112 for processing the information. The computer system 111 also includes a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 further includes a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 also includes a disk controller 116 coupled to the bus 112 to control one or more storage devices for storing information and instructions, such as a magnetic hard disk 117, and a removable media drive 118 (e.g., floppy disk drive, read-only compact disc drive, read/write compact disc drive, compact disc jukebox, tape drive, and removable magneto-optical drive). The storage devices may be added to the computer system 111 using an appropriate device interface (e.g., small computer system interface (SCSI), integrated device electronics (IDE), enhanced-IDE (E-IDE), direct memory access (DMA), or ultra-DMA).

Further, exemplary embodiments include or incorporate at least one database which may store software, descriptive data, system data, digital images and any other data item required by the other components necessary to effectuate any embodiment of the present system known to one having ordinary skill in the art. The database may be provided, for example, as a database management system (DBMS), a relational database management system (e.g., DB2, ACCESS, etc.), an object-oriented database management system (ODBMS), a file system or another conventional database package as a few non-limiting examples. The database can be accessed via a Structure Query Language (SQL) or other tools known to one having skill in the art.

Still referring to FIG. 1, the computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to bus 112 to control a display 120, such as a cathode ray tube (CRT), liquid crystal display (LCD) or any other type of display, for displaying information to a computer client. The computer system includes input devices, such as a keyboard 121 and a pointing device 122, for interacting with a computer client and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the exemplary embodiments in response to the processor 113 executing one or more sequences of one or more instructions contained in a memory, such as the main memory 114. Such instructions may be read into the main memory 114 from another computer readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the exemplary embodiments and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, exemplary embodiments includes software for controlling the computer system 111, for driving a device or devices for implementing the exemplary embodiments, and for enabling the computer system 111 to interact with a human client. Such software may include, but is not limited to, device drivers, operating systems, development tools, and applications software. Such computer readable media further includes the computer program product of exemplary embodiments for performing all or a portion (if processing is distributed) of the processing performed in implementing exemplary embodiments.

The computer code devices of exemplary embodiments may be any interpretable or executable code mechanism, including but not limited to scripts, interpretable programs, dynamic link libraries (DLLs), Java classes, and complete executable programs. Moreover, parts of the processing of exemplary embodiments may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media includes dynamic memory, such as the main memory 114. Transmission media includes coaxial cables, copper wire and fiber optics, including the wires that make up the bus 112. Transmission media also may also take the form of acoustic or light waves, such as those generated during radio wave and infrared data communications.

Various forms of computer readable media may be involved in carrying out one or more sequences of one or more instructions to processor 113 for execution. For example, the instructions may initially be carried on a magnetic disk of a remote computer. The remote computer can load the instructions for implementing all or a portion of exemplary embodiments remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 carries the data to the main memory 114, from which the processor 113 retrieves and executes the instructions. The instructions received by the main memory 114 may optionally be stored on storage device 117 or 118 either before or after execution by processor 113.

The computer system 111 also includes a communication interface 123 coupled to the bus 112. The communication interface 123 provides a two-way data communication coupling to a network link 124 that is connected to, for example, a local area network (LAN) 125, or to another communications network 126 such as the Internet. For example, the communication interface 123 may be a network interface card to attach to any packet switched LAN. As another example, the communication interface 123 may be a wireless link. In any such implementation, the communication interface 123 sends and receives electrical, electromagnetic or optical signals that carry digital data streams representing various types of information.

The network link 124 typically provides data communication through one or more networks to other data devices. For example, the network link 124 may provide a connection to another computer or remotely located presentation device through a local network 125 (e.g., an 802.11-compliant wireless network) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

Other aspects of exemplary embodiments may include data transmission and Internet-related activities. See Preston Gralla, How the Internet Works, Ziff-Davis Press (1996), which is hereby incorporated by reference into this patent application. Still other aspects of exemplary embodiments may utilize wireless data transmission.

The exemplary embodiments may provide an analytic tool for analyzing digital and social media. Digital and social media may include web-based technologies that use the Internet to publish user generated content. A social media application may use web-based technology for social interaction. As described above, some examples of digital and social media may include social networking applications, such as TWITTER, LINKEDIN, FACEBOOK, INSTAGRAM, GOOGLE+, PINTEREST and the like. Other types of digital and social media applications may include wikis, blogs, etc. as would be understood by a person of ordinary skill in the art.

Turning now to the exemplary embodiment of FIG. 2, a method for establishing an online advocacy crowd 200 may be shown. For example, a user of the method 200 may be a group, individual, business, or organization that may be interested in promoting a particular issue, message, campaign, product, brand, or the like. For purposes of explanation, exemplary embodiments of an advocacy platform may be conceptually described by way of a non-limiting example, for instance, a “Save the Flag” campaign. At step 201, a crowd page may be generated by the user. The crowd page may be, for example, a website with information about a particular issue, message, campaign, product, brand or the like that the user is wishing to promote or build.

As explained in more detail below, the crowd page may also provide information for and about members of a crowd. Furthermore, users may have the ability to link one or more digital and social media accounts to the crowd page to drive potential crowd members, current crowd members, or other targeted individuals to the crowd page. The crowd page may be named based on the particular issue, message, campaign etc., which is important to the user.

At step 202, a user may generate at least one keyword or phrase to search for across a plurality of digital and social media sources. For example, a listening tool or module may be utilized to capture information from digital and social media sources related to the keywords and phrases. The keywords or phrases may be important or relevant to the campaign or message. For example, in the “Save the Flag” campaign, a user may choose to generate terms to search or listen for, including words and phrases such as “Flags,” “Flag Waving,” “American Flag,” or other similar words or phrases.

Furthermore, a user may also generate keywords or phrases that may indicate a negative connotation with respect to the campaign or message. A user may wish to avoid, or not listen for, such keywords or phrases. For example, in the “Save the Flag” campaign, a user may generate a negative keyword or phrase such as “Flag Burning.”

After a user has generated the keywords and phrases at step 202, the user may enter the keywords and phrases in an online interface at step 204. At step 206, the user may selectively apply one or more filters which may be utilized to further target a search. For example, a user may wish to target a particular geographic region. Thus, the user may apply a geographic filter at any level of granularity. For example, a national, international, state, congressional district, zip code, or other geographic filter may be selectively applied. Therefore, a user of method 200 may choose particular keywords and phrases, as well as where to search for the keywords or phrases.

Further, as would be understood by a person of ordinary skill in the art, the filter may not be limited to a geographic filter, but could be any type of information filter known in the art. For example, a user may choose to filter by a particular digital or social media platform.

At step 208, the user may begin a search for the keywords or phrases established in step 204, as applied against any filters applied in step 206. A user may search or listen across a plurality of digital and social media sources such as, for example, TWITTER, LINKEDIN, FACEBOOK, INSTAGRAM, GOOGLE+, PINTEREST or the like. For example, as would be understood by a person of ordinary skill in the art, a listening, mining, or search tool and/or module may be utilized to capture information of a post from a digital or social media source which contains or relates to the keywords and phrases. For instance, continuing from the above example, a listening tool may listen for the keywords “Flags,” “Flag Waving,” “American Flag,” or iterations thereof.

At step 210, a post on any social or digital media source may be identified that contains at least one of the keywords or phrases. At step 212, a plurality of posts may be identified that contain at least one of the keywords or phrases, and a populated list of these posts may be generated. Each post may be saved and tagged by originating source.

At step 214, for each post in the populated list from step 212, a contact may be determined. The contact may be, for example, the author of the post containing the keyword or phrase. Once the contact for each post in the populated list is determined, the contact may be saved and identified as a potential crowd member. At step 216, once all contacts have been saved as potential crowd members, a user may select certain contacts to add or invite as crowd members by directing them to the crowd page.

The user may selectively add or invite contacts as crowd members based on certain criteria or analytics at step 216. A plurality of crowd members may form a crowd.

Referring generally to the method 200, in some exemplary embodiments, a user may want to define a set of top talkers, or those that may potentially be strong advocates for the cause or message and invite them as potential crowd members. A process may be run to determine potential strong advocates or crowd members, for example, by determining a Klout score for each contact. The process may run intermittently at a set time interval, or at the user's discretion. The process may identify the most recent contacts for evaluation, and may further request a Klout ID and receive a Klout Score for each contact. The Klout ID and Score for each contact may be saved. A reply process may be used to reach out to any potential crowd member by sending a message to the contact.

Turning now to FIG. 3, steps for automatically and continuously updating the search process of the digital and social media sources may be shown. For example, after the steps discussed in FIG. 2 above, the search of the keywords or phrases may be automatically reapplied at set time intervals at step 302. For example, the search of the same keywords and phrases established in step 202 may be resubmitted at any time interval, for instance, instantaneously at the user's discretion, every five minutes, every ten minutes etc., to update the results.

At step 304, additional posts may be identified that contain the same keywords or phrases. However, to ensure that the additional posts are unique, a determination is made at step 306 as to whether the additional posts are duplicates of any post identified in a previous search. At step 308, a second populated lists of posts may be returned, which may include posts that are not duplicates of a previous post. It should be understood that the process of FIG. 3 may be repeated as many times as necessary, and at any interval to continuously listen, mine and update the keyword or phrase search of the digital and social media sources.

Turning now to FIG. 4, steps for updating or adding additional contacts in step 214 may be shown. For example, after the steps discussed in FIG. 2 above, the search of the keywords or phrases may be automatically reapplied at set time intervals at step 402. For example, the search of the same keywords and phrases established in step 202, may be resubmitted at any time interval, for instance, instantaneously at the user's discretion, every five minutes, every ten minutes etc., to update the results.

At step 404, additional posts may be identified that contain the same keywords or phrases. At step 406, similar to step 214 above, a contact may be determined for the additional posts. The contact may be, for example, the author of the post containing the keyword or phrase. However, to ensure that the contacts are unique, a determination may be made at step 408 as to whether the additional contacts may be duplicates of any contact identified in a previous search.

At step 410, additional contacts are saved if the contacts are not duplicates of any previous contact. It should be understood that the process of FIG. 4 may be repeated as many times as necessary, and at any interval to continuously listen, mine and update the keyword or phrase search of the digital and social media sources, and to continuously identify contacts and increase the size of a particular crowd.

In another exemplary embodiment, users of the method described with respect to FIGS. 2-4 may also have the similar ability to listen to or search existing groups across digital or social media platforms including, for example, fans and followers of other digital or social media accounts. For example, users could listen or search a Twitter handle of a member of Congress to listen to what their public followers are saying. In another example, as applied to the “Save the Flag” campaign described above, users may choose to listen to a major manufacturer of American Flags. In this example, users may be able to enter the Twitter handle, for instance, of the major manufacturer to listen and follow additional public comments from fans and followers.

With reference to FIG. 5, an exemplary embodiment of a crowd page may be shown. As previously described, the crowd page may be, for example, a website with information about a particular issue, message, campaign, product, brand or the like that the user is wishing to promote or build. As demonstrated above with reference to FIGS. 2-4, user generated keywords are used to identify posts relating to associated issues of a particular crowd page. Contact information for the author of each post may be determined and saved as potential crowd members.

Furthermore, users may have the ability to link one or more of their own digital or social media accounts to the crowd page to drive potential crowd members, current crowd members, or other targeted individuals to the crowd page. Crowd page may include, for example, the name, information about the crowd page and video content. If a person is not a member of the crowd represented by crowd page, an offer to join or follow the crowd may be shown. Persons can join, for example, by FACEBOOK, TWITTER, email, or by other means known to those of ordinary skill in the art.

Crowd page may also have a share feature, for any person to share the crowd page to others. Crowd page may have other features as well. For example, a comment feature for current crowd members to post a comment, or a link to contact a crowd member's Congressional representative.

Referring now to FIG. 6, an exemplary embodiment of analytics or listen page of the advocacy platform may be shown. Analytics or listen page may provide analysis and statistics including total persons that are talking about the keywords or phrases associated with the crowd on digital and social media platforms. For example, the analytics or listen page may provide information regarding persons or potential crowd members contacted, crowd members that have joined the crowd, and by what means the crowd members accessed the crowd page and joined the crowd.

As further shown in FIG. 6, information may be represented in various graphical forms, for example, graphs, pie charts, Venn diagrams, and the like. An analysis may be shown for metrics. For example, post frequency, filter breakdown (geographically by State as shown), an average Klout score of crowd members, total unique visits, and crowd shares may be provided. Analytics or listen page may also include information on crowd advertisements that may assist users with online advertisements which may further increase the size of the crowd. Analytics or listen page may also include a link to crowd page and communications page.

Referring now to FIG. 7, an exemplary embodiment of a communications page of the advocacy platform may be shown. Communications page may provide a stream of persons talking about the keywords or phrases for which a user is listening. Users may then have the ability to directly interface with these people by using a reply feature on the communications page. Communications page may also apply a filter to the stream. The filter may be, for example, a geographic location or particular digital or social media platform.

Referring generally to FIGS. 8-10, further exemplary embodiments of pages for an online advocacy platform may be shown. For example, FIG. 8 may show an online dashboard that may show an overview of an issue, campaign or message. For example, the page displayed in FIG. 8 may show how many people are talking about an issue, how many people have been messaged, new members, weekly statistics, keyword match summary, Klout scores, analytics and so forth.

FIG. 9 may show another exemplary embodiment of a page for an online advocacy platform. For example, FIG. 9 may show crowd members or users including, for example, by name, screen name, network, join date, and location. The online advocacy platform may include other features, for example, a breakdown of posts by networks, the ability to reply to users directly, and the ability to remove users or crowd members or follow them as necessary.

FIG. 10 may show another exemplary embodiment of a page for an online advocacy platform. For example, FIG. 10 may show an analytics page which may include, for example, a breakdown of a campaign with customizable and exportable, real time analytics. The analytics may include keyword performance and crowd demographics. A list of crowd members with links to their social media accounts and email may be available, which may enable direct communication from the platform.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for establishing an online advocacy crowd, comprising:
generating a crowd page;
naming the crowd page based upon an agenda of a user,
generating at least one keyword from the user;
entering the at least one keyword into an online interface;
selectively applying one or more filters;
searching for the at least one keyword by listening across a plurality of digital and social media sources;
identifying at least one post containing the at least one keyword;
returning a populated list including the at least one post;
determining a contact for the at least one post containing the at least one keyword;
saving the contact as a potential crowd member;
selectively inviting the contact to join as a crowd member on the crowd page, wherein a plurality of crowd members form a crowd.

2. The method of claim 1, further comprising;
automatically reapplying the search for the at least one keyword at a set time interval;
identifying at least one second post with the at least one keyword;
determining if the at least one second post is a duplicate of a previous post;
returning a second populated list including the at least one second post if it is not a duplicate of a previous post.

3. The method of claim 1, further comprising:
automatically reapplying the search for the at least one keyword at a set time interval;
identifying at least one second post with the at least one keyword;
determining a contact for the at least one post containing the at least one keyword;
determining if the contact for the at least one second post is a duplicate of a saved contact;
saving the contact for the at least one second post only if the contact for the at least one second post is not a duplicate of a saved contact.

4. The method of claim 1, wherein the at least one filter is a geographic filter.

5. The method of claim 1, further comprising:
linking at least one social media account of the user to at least one of the crowd page, a potential crowd member, crowd member, or a crowd; and
targeting messages from the at least one social media account of the user to at least one of a targeted individual, a potential crowd member, crowd member, or a crowd.

6. The method of claim 1, further comprising:
saving and tagging each post by an originating source of the post.

7. The method of claim 6, wherein the originating source is one of Twitter, Linkedin, Facebook, Instagram, Google+ and Pinterest.

8. The method of claim 1, wherein a crowd member can be member of a plurality of crowds.

9. The method of claim 1, wherein the crowd page includes at least one of information about the crowd, a video source, a join crowd feature, a share page feature, and a comment feature.

10. The method of claim 1, further comprising:
compiling a set of analytics for the crowd; and
displaying the set of analytics on an analytics page accessible by the user.

11. The method of claim 10, wherein the analytics include at least one of total number of persons posting about the at least one keyword or phrases, number of potential crowd members contacted, crowd members that have joined the crowd, how crowd members joined the crowd, post frequency, filter breakdown, an average Klout score of crowd members, total unique visits, and crowd shares.

12. The method of claim 10, further comprising:
linking at least one digital or social media account of the user the analytics page.

13. The method of claim 1, further comprising:
displaying a communication page to the user, the communication page displaying a stream of posts with the at least one keyword; and
permitting the user to directly communicate with a contact or reply to a post.

14. The method of claim 1, further comprising:
permitting users to listen to at least one of fans and followers of other digital or social media accounts.

15. A method for establishing an online advocacy crowd, comprising:
generating a crowd page;
naming the crowd page based upon an agenda of a user,
generating at least one keyword from the user;
searching for the at least one keyword by listening across a plurality of digital and social media sources;
identifying at least one post containing the at least one keyword;
determining a contact for the at least one post containing the at least one keyword;
saving the contact as a potential crowd member;

16. The method of claim 15, further comprising:
entering the at least one keyword into an online interface.

17. The method of claim 15, further comprising:
selectively applying one or more filters.

18. The method of claim 15, further comprising:
returning a populated list including the at least one post.

19. The method of claim 15, further comprising:
selectively inviting the contact to join as a crowd member on the crowd page, wherein a plurality of crowd members form a crowd.
